(19) United States
(12) Patent Application Publication
(10) Pub. No.: US 2010/0327567 A1
(43) Pub. Date: Dec. 30, 2010

(54) ROOF AIRBAG APPARATUS FOR VEHICLES

(75) Inventors: Jun Yeol CHOI, Seoul (KR); Hyeong Ho Choi, Gwangmyeong-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/613,348

(22) Filed: Nov. 5, 2009

(30) Foreign Application Priority Data
Jun. 30, 2009 (KR) 10-2009-0058803

(51) Int. Cl. B60R 21/16

(52) U.S. Cl. 280/730.2

(57) ABSTRACT

A roof airbag apparatus may include an inflator, a containing pouch, an airbag cushion and an airbag door. The inflator supplies gas pressure to the airbag cushion. The containing pouch is installed inside a headlining of a vehicle roof The containing pouch has a receiving space therein. The airbag cushion is disposed in the receiving space of the containing pouch. The airbag cushion is deployed downwards by gas pressure supplied from the inflator. The airbag door allows an opening to be formed in the headlining by an opening motion of the airbag door when the airbag cushion is deployed.

### CROSS-REFERENCE TO RELATED APPLICATIONS

moon The present application claims priority to Korean Patent Application Number 10-2009-0058803 filed on Jun. 30, 2009, the entire contents of which application is incorporated herein for all purpose by this reference.

### BACKGROUND OF THE INVENTION

1. Field of the Invention

The present invention relates generally to roof airbag apparatuses which deploy airbag cushions from vehicle roofs and, more particularly, to a roof airbag apparatus for vehicles which is configured such that the weight and volume thereof can be minimized.

2. Description of Related Art

Generally, airbag systems are classified into a driver seat airbag which protects a driver, a passenger seat airbag which protects a passenger sitting in the passenger seat, and a side airbag and a roof airbag.

In the case of the roof airbag, an airbag module is installed in a vehicle roof The airbag module of the roof airbag includes a housing which is installed in the vehicle roof, an inflator which provides gas pressure, and an airbag cushion which is inflated by gas pressure supplied from the inflator. When a vehicle collision occurs, the airbag cushion is deployed downwards by the operation of the inflator to protect a passenger from impact.

However, as shown in FIG. 6, in the conventional technique, because of elements of an airbag module 20, such as a housing, an inflator, an airbag cushion, etc., having predetermined volume, a portion of a vehicle roof 10 which contains the airbag module 20 therein protrudes a predetermined distance downwards. Such a protrusion (P) of the vehicle roof 10 may collide with the head of the passenger when a vehicle collision occurs. Furthermore, when the vehicle is involved in a collision, the airbag cushion may injure the passenger due to shear force generated by contact between the passenger and the airbag cushion.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a roof airbag apparatus for vehicles which is configured such that the volume thereof is minimized, thus preventing the roof airbag apparatus from colliding with the head of a passenger when a vehicle collision occurs.

In an aspect of the present invention, the roof airbag apparatus for a vehicle, may include an inflator supplying gas pressure, a containing pouch installed inside a headlining of a vehicle roof, wherein the containing pouch includes a receiving space therein, an airbag cushion disposed in the receiving space of the containing pouch, wherein the airbag cushion is deployed downwards by the gas pressure supplied from the inflator, and an airbag door formed at the headlining and opened by the airbag cushion.

The containing pouch may be torn by the airbag cushion when a predetermined pressure is applied to the containing pouch by deployment of the airbag cushion.

Holding blades may protrude from first and second ends of the containing pouch, each of the holding blades having a plurality of fastening holes therein, wherein locking members may fasten the holding blades to the vehicle roof through the fastening holes.

In another aspect of the present invention, the roof airbag apparatus may further include a holder in close contact with each of the holding blades, the holder having insert holes corresponding to the fastening holes, and locking members fastening the holder to the vehicle roof through the fastening holes and the insert holes.

The airbag door may include a bent hinged portion hinged to the headlining of the vehicle roof, and a tear line formed along a boundary between the airbag door and the headlining by forming a tear groove such that when the airbag cushion is deployed, an opening is formed in the headlining by the airbag cushion.

The containing pouch may be fastened to an inside of the headlining through a mounting unit installed in the vehicle roof, and wherein the mounting unit includes a front center rail provided in a front side of the vehicle roof, and a rear center rail provided in a rear side of the vehicle roof such that the containing pouch is disposed between the front center rail and the rear center rail and first and second ends of the containing pouch are connected to the front and rear center rails respectively.

The containing pouch may be made of flexible material to absorb impact, wherein the receiving space of the containing pouch is maintained in a vacuum by exhausting air therefrom to reduce a volume of the containing pouch.

The inflator may be disposed in the receiving space of the containing pouch, wherein the inflator is installed to the front center rail.

In further another aspect of the present invention, the roof airbag apparatus for a vehicle, may include an inflator supplying gas pressure, an airbag cushion installed inside a headlining of a vehicle roof, wherein the airbag cushion is deployed downwards by the gas pressure supplied from the inflator, and an airbag door formed at the headlining, wherein the airbag door is opened by the airbag cushion, wherein the inflator is installed inside the airbag cushion.

The airbag cushion may be fastened to an inside of the headlining through a mounting unit installed in the vehicle roof, wherein the mounting unit includes a front center rail provided in a front side of the vehicle roof, and a rear center rail provided in a rear side of the vehicle roof such that the airbag cushion is disposed between the front center rail and the rear center rail and first and second ends of the airbag cushion are connected to the front and rear center rails respectively.

Holding blades may be formed at the first and second ends of the airbag cushion, each of the holding blades having a plurality of fastening holes therein and locking members fasten the holding blades to the vehicle roof through the fastening holes.

In still further another aspect of the present invention, the roof airbag apparatus may further include a holder in close contact with each of the holding blades, the holder having insert holes corresponding to the fastening holes, and the locking members fastening the holder to the vehicle roof through the fastening holes and the insert holes.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view showing the construction of a vehicle roof provided with a roof airbag apparatus, according to an exemplary embodiment of the present invention.

FIG. 2 is a partial sectional view taken along the line “A-A” of FIG. 1;

FIG. 3 is a perspective view illustrating a containing pouch storing an airbag cushion therein according to the present invention.

FIG. 4A is a view showing the state of the roof airbag apparatus when the airbag cushion is not in operation.

FIG. 4B is a view showing the state of the roof airbag apparatus when the airbag cushion is deployed.

FIG. 5A is a view showing the state of a roof airbag apparatus when an airbag cushion is not in operation, according to another exemplary embodiment of the present invention.

FIG. 5B is a view showing the state of the roof airbag apparatus of FIG. 5A when the airbag cushion is deployed.

FIG. 6 is a view showing the construction of a conventional roof airbag apparatus.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, various exemplary embodiments of the present invention will be described in detail with reference to the attached drawings.

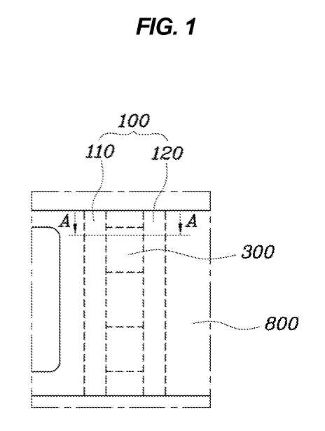

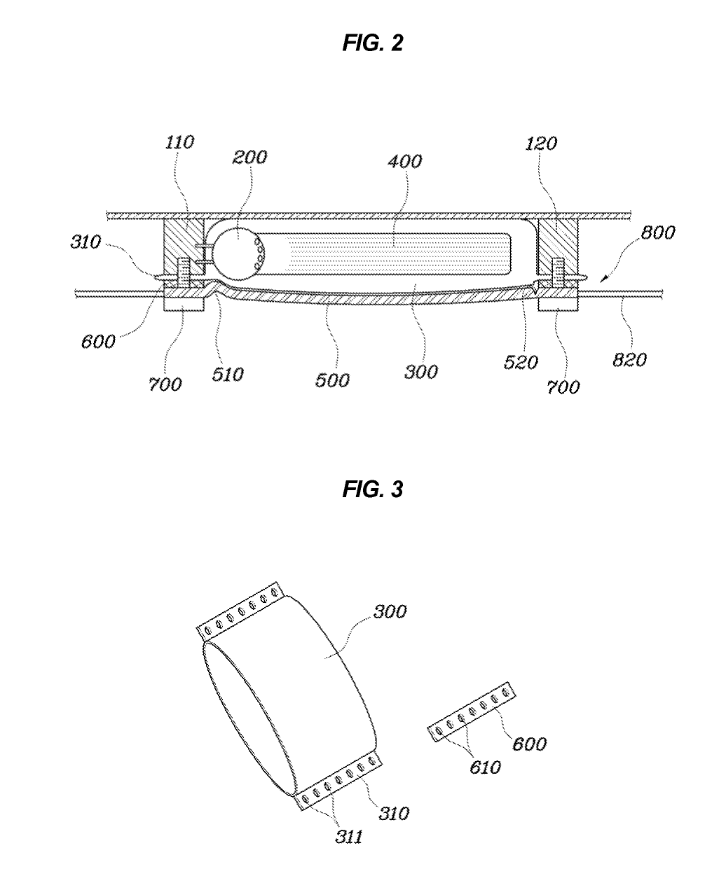

As shown in FIGS. 1 through 3, the present invention, as an exemplary embodiment, provides a roof airbag apparatus for vehicles which is minimized in volume, thus preventing it from colliding with the head of a passenger when a vehicle collision occurs. The roof airbag apparatus includes a containing pouch 300 which has a receiving space therein.

The containing pouch 300 is installed inside a headlining 820 of a vehicle roof 800. In detail, the containing pouch 300 is mounted to the vehicle roof 800 by a mounting unit 100. The mounting unit 100 comprises elements which are previously installed in the vehicle roof 800 and are capable of fastening the containing pouch 300 to the vehicle roof 800. In the exemplary embodiment, vehicle body center rails, such as a front center rail 110 and a rear center rail 120, are used as the mounting unit 100.

In detail, the front center rail 110 is disposed in the front side of the vehicle roof 800 and oriented in the lateral direction of the vehicle. The rear center rail 120 is disposed in the rear side of the vehicle roof 800 and oriented in the lateral direction of the vehicle. The containing pouch 300 is disposed between and fastened to the front center rail 110 and the rear center rail 120. As such, since the containing pouch 300 is disposed between the front center rail 110 and the rear center rail 120, a separate housing for holding the containing pouch 300 is not required. Furthermore, the roof airbag apparatus can be prevented from being configured in a shape such that it protrudes downwards from the vehicle roof 800.

Holding blades 310 are provided on the front and rear ends of the containing pouch 300 to prevent damage to the containing pouch 300 attributable to shear force. In detail, the holding blades 310 protrude from the front and rear ends of the containing pouch 300 and are respectively fastened to the front center rail 110 and the rear center rail 120. In other words, when the airbag cushion 400 is deployed, the movement of the airbag cushion 400 must be controlled, and shear force generated between the passenger and the airbag cushion 400 must also be controlled. To achieve this purpose, in the exemplary embodiment, the containing pouch 300 is stably fastened to the front center rail 110 and the rear center rail 120 through the holding blades 310.

In addition, a tear line (not shown) may be formed in the containing pouch 300. When the airbag cushion 400 is deployed, the tear line is broken. The tear line is formed such that when a predetermined pressure or more is applied to the containing pouch 300 by inflation of the airbag cushion 400, the containing pouch 300 can be torn and the airbag cushion 400 can be smoothly deployed.

The holding blades 310 are supported by holders 600 and fastened to the mounting unit 100 by locking members 700. Each holder 600 is configured such that it overlaps the corresponding holding blade 310. In the state in which the holders 600 compress the holding blades 310 to the mounting unit 100, the holding blades 310 and the holders 600 are fastened to the mounting unit 100 by the locking members 700, for example, bolts, nuts, rivets, pins, etc. Here, each fastening member 700 is tightened into the front center rail 110 or the rear center rail 120 through an insert hole 610 of the holder 600 and a fastening hole 311 of the corresponding holding blade 310. Therefore, the mounting unit 100, the holding blades 310 and the holders 600 can be tightly fastened to each other. In addition, the locking members 700 may also fasten an airbag door 500, along with the holding blades 310 and the holders 600, to the mounting unit 100.

The containing pouch 300 is made of flexible material which can absorb impact. For example, the containing pouch 300 is made of fabric, vinyl, rubber, etc. Particularly, in the case where the containing pouch 300 is made of fabric, it is preferable that the holding blades 310 of the containing pouch 300 be fastened to the mounting unit 100 after sufficiently pulling them in opposite directions such that the receiving space of the containing pouch 300 is minimized. If vinyl or rubber is used as the material of the containing pouch 300, it is preferable that the receiving space of the containing pouch 300 enter a vacuum state by exhausting air such that the receiving space is minimized.

Meanwhile, the roof airbag apparatus further includes an inflator 200 which provides gas pressure to the airbag cushion 400, and an airbag door 500 which closes an opening of the vehicle roof 800 under normal conditions and opens the opening when the airbag cushion 400 is deployed.

The inflator 200 is constructed such that gas of high pressure can be supplied to the airbag cushion 400 when a vehicle collision occurs. For example, the inflator 200 may be connected to the airbag cushion 400 through a separate gas supply tube or, alternatively, it may directly communicate with the airbag cushion 400 through a gas hole.

In the case where the inflator 200 directly communicates with the airbag cushion 400, the inflator 200 is constructed such that it is fastened to the mounting unit 100 and the gas hole thereof is connected to the airbag cushion 400. Here, the inflator 200 which is connected to the airbag cushion 400 may be installed in the containing pouch 300 or, alternatively, it may be disposed outside the containing pouch 300.

Meanwhile, when the airbag cushion 400 is inflated and deployed, the airbag door 500 opens the opening which is formed in the headlining 820 of the vehicle roof 800. In detail, the airbag door 500 has a bent hinged portion 510 which is hinged to the headlining 820, and a tear line which is formed such that when the airbag cushion 400 is deployed, it is torn to open the opening. The tear line is formed by a tear groove 520 which forms a boundary between the airbag door 500 and the headlining 820.

In other words, the tear groove 520 is formed on the border of the airbag door 500, other than a portion of the border in which the bent hinged portion 510 is formed. The border of the airbag door 500 is torn along the tear groove 520 when the airbag cushion 400 is deployed, thus forming the opening in the headlining 820. Therefore, the airbag cushion 400 that is being inflated is deployed towards the passenger.

The process of assembling the present invention having the above-mentioned construction will be described in detail below.

First, the airbag cushion 400 is folded in a predetermined shape. The folded airbag cushion 400 is inserted into the containing pouch 300. Thereafter, the containing pouch 300 is packed after minimizing the size thereof. Depending on the material of the containing pouch 300, the method used to pack the containing pouch 300 may be varied. For example, if the containing pouch 300 is made of fabric, the holding blade 310 of the containing pouch 300 that contains the airbag cushion 400 therein are sufficiently pulled in opposite directions and fastened to the mounting unit 100. In the case of a containing pouch 300 made of vinyl or rubber, after the airbag cushion 400 is inserted into the containing pouch 300, the receiving space of the containing pouch 300 forms a vacuum by exhausting air from the receiving space.

After the volume of the containing pouch 300 is minimized, the containing pouch 300 is disposed between the front center rail 110 and the rear center rail 120. Subsequently, the containing pouch 300 is fastened to the front center rail 110 and the rear center rail 120 by the holders 600 and locking members 700.

As such, in the present invention, the volume of the containing pouch 300 which contains the airbag cushion 400 therein is minimized. The containing pouch 300 is disposed in a surplus space of the vehicle roof 800. Peripheral elements are used to install the roof airbag apparatus to the vehicle roof 800. Therefore, the present invention can prevent a portion of the headlining 820 from protruding from the vehicle roof 800 attributable to the installation of the roof airbag apparatus. Furthermore, modification of the design of the vehicle roof 800 due to the installation of the roof airbag apparatus can be minimized.

Hereinafter, the operation of the roof airbag apparatus according to the present invention will be explained in detail.

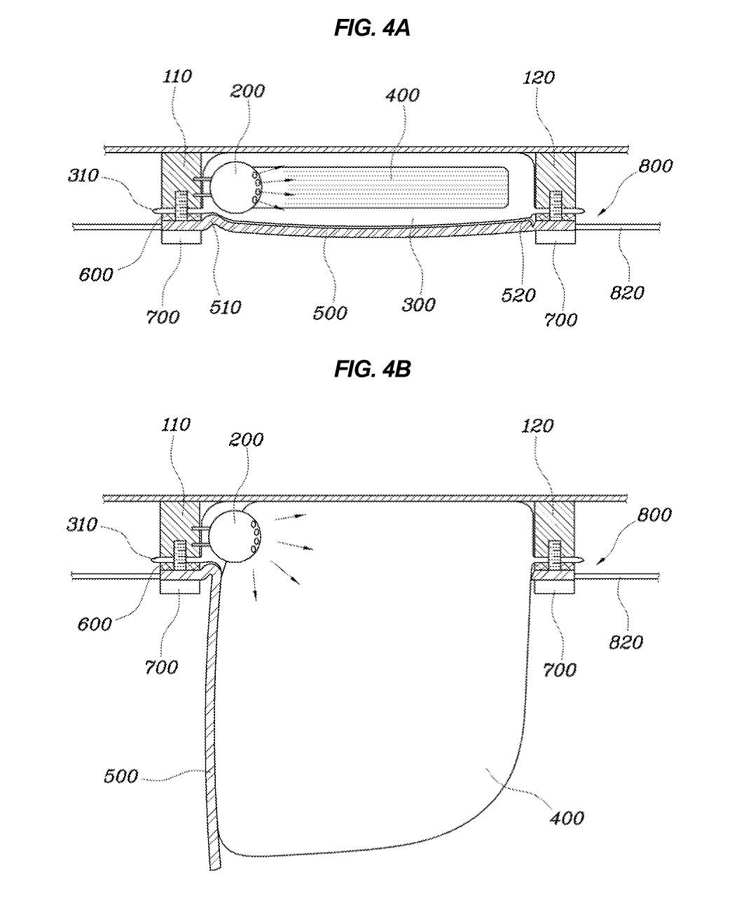

As shown in FIG. 4A, when a signal generated by a vehicle collision is transmitted to the inflator 200, the inflator 200 generates gas of high pressure and provides it to the airbag cushion 400. Then, the airbag cushion 400 is inflated by the gas of high pressure. The airbag cushion 400 that is being inflated tears the tear line of the containing pouch 300 and presses the airbag door 500.

Thereafter, as shown in FIG. 4B, the tear line 520 of the airbag door 500 is torn by the pressure of the airbag cushion 400. Then, the airbag door 500 rotates around the bent hinged portion 510 that functions as a rotating shaft. The airbag cushion 400 is deployed downwards, that is, towards the passenger.

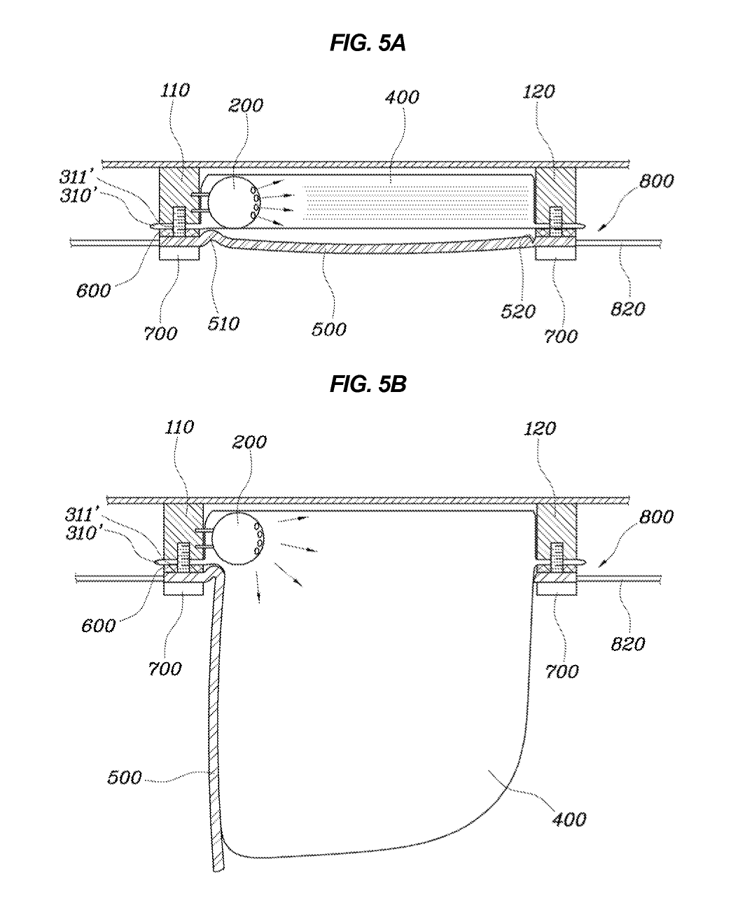

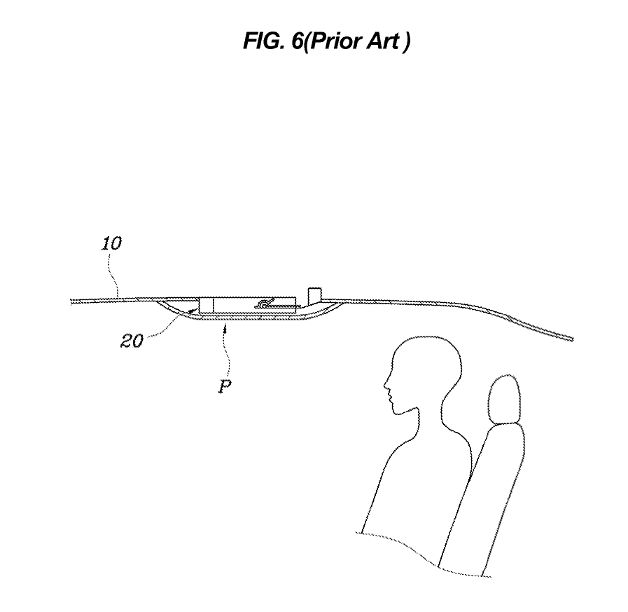

Meanwhile, FIGS. 5A and 5B illustrate another exemplary embodiment of the present invention. As shown in FIGS. 5A and 5B, a roof airbag apparatus of this exemplary embodiment includes an inflator 200, an airbag cushion 400 which is directly fastened to the inside of the headlining 820 of the vehicle roof 800, and an airbag door 500 which closes an opening formed in the headlining 820 under normal conditions and opens the opening when the airbag cushion 400 is deployed.

The constructions of the inflator 200 and the airbag door 500 remain the same as those of the prior exemplary embodiment, therefore further explanation will be omitted. However, unlike the prior exemplary embodiment, the airbag cushion 400 is fastened to the headlining 820 of the vehicle roof 800, and holding blades 310′ are provided on both ends of the airbag cushion 400. A plurality of fastening holes 311′ is formed in the holding blades 310′.

Each of the holding blades 310′ may be configured by folding the corresponding portions of the airbag cushion 400 and sewing the folded portions or may be configured such that a separate member is attached to the airbag cushion 400. Here, each of the holding blades 310′ must be configured such that it can withstand the inflation force generated when the airbag cushion is deployed.

As described above, the present invention minimizes the weight and volume of the roof airbag apparatus and installs the roof airbag apparatus inside a vehicle roof, thus reducing variation in the design of the vehicle roof due to the installation of the roof airbag apparatus.

Furthermore, the present invention prevents a portion of a headlining of the vehicle roof from protruding attributable of the installation of the roof airbag apparatus, thus solving a conventional problem in that if the airbag apparatus is configured such that a portion of the headlining protrudes from the vehicle roof, the head of a passenger may collide with the protruding portion of the headlining when a vehicle collision occurs.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A roof airbag apparatus for a vehicle, comprising:
an inflator supplying gas pressure;
a containing pouch installed inside a headlining of a vehicle roof, wherein the containing pouch includes a receiving space therein;
an airbag cushion disposed in the receiving space of the containing pouch, wherein the airbag cushion is deployed downwards by the gas pressure supplied from the inflator; and
an airbag door formed at the headlining and opened by the airbag cushion.

2. The roof airbag apparatus as set forth in claim 1, wherein the containing pouch is torn by the airbag cushion when a predetermined pressure is applied to the containing pouch by deployment of the airbag cushion.

3. The roof airbag apparatus as set forth in claim 1, wherein holding blades protrude from first and second ends of the containing pouch, each of the holding blades having a plurality of fastening holes therein.

4. The roof airbag apparatus as set forth in claim 3, further comprising locking members fastening the holding blades to the vehicle roof through the fastening holes.

5. The roof airbag apparatus as set forth in claim 3, further comprising:
a holder in close contact with each of the holding blades, the holder having insert holes corresponding to the fastening holes; and
locking members fastening the holder to the vehicle roof through the fastening holes and the insert holes.

6. The roof airbag apparatus as set forth in claim 1, wherein the airbag door has:
a bent hinged portion hinged to the headlining of the vehicle roof; and
a tear line formed along a boundary between the airbag door and the headlining by forming a tear groove such that when the airbag cushion is deployed, an opening is formed in the headlining by the airbag cushion.

7. The roof airbag apparatus as set forth in claim 1, wherein the containing pouch is fastened to an inside of the headlining through a mounting unit installed in the vehicle roof, and wherein the mounting unit comprises a front center rail provided in a front side of the vehicle roof, and a rear center rail provided in a rear side of the vehicle roof such that the containing pouch is disposed between the front center rail and the rear center rail and first and second ends of the containing pouch are connected to the front and rear center rails respectively.

8. The roof airbag apparatus as set forth in claim 1, wherein the containing pouch is made of flexible material to absorb impact.

9. The roof airbag apparatus as set forth in claim 8, wherein the receiving space of the containing pouch is maintained in a vacuum by exhausting air therefrom to reduce a volume of the containing pouch.

10. The roof airbag apparatus as set forth in claim 1, wherein the inflator is disposed in the receiving space of the containing pouch.

11. The roof airbag apparatus as set forth in claim 10, wherein the inflator is installed to the front center rail.

12. A roof airbag apparatus for a vehicle, comprising:
an inflator supplying gas pressure;
an airbag cushion installed inside a headlining of a vehicle roof, wherein the airbag cushion is deployed downwards by the gas pressure supplied from the inflator; and
an airbag door formed at the headlining, wherein the airbag door is opened by the airbag cushion.

13. The roof airbag apparatus as set forth in claim 12, wherein the inflator is installed inside the airbag cushion.

14. The roof airbag apparatus as set forth in claim 12, wherein the airbag cushion is fastened to an inside of the headlining through a mounting unit installed in the vehicle roof, wherein the mounting unit comprises a front center rail provided in a front side of the vehicle roof, and a rear center rail provided in a rear side of the vehicle roof such that the airbag cushion is disposed between the front center rail and the rear center rail and first and second ends of the airbag cushion are connected to the front and rear center rails respectively.

15. The roof airbag apparatus as set forth in claim 14, wherein holding blades are formed at the first and second ends of the airbag cushion, each of the holding blades having a plurality of fastening holes therein and locking members fasten the holding blades to the vehicle roof through the fastening holes.

16. The roof airbag apparatus as set forth in claim 14, further comprising:
a holder in close contact with each of the holding blades, the holder having insert holes corresponding to the fastening holes; and
the locking members fastening the holder to the vehicle roof through the fastening holes and the insert holes.

17. The roof airbag apparatus as set forth in claim 12, wherein the inflator is installed to the front center rail.
